(19) United States
(12) Patent Application Publication
(10) Pub. No.: US 2025/0375646 A1
(43) Pub. Date: Dec. 11, 2025

(54) METHODS FOR SEPARATING AN INPUT FEEDSTOCK USING THERMAL PLASMA AND SYSTEMS THEREOF

(71) Applicant: REFACTURE, INC., Washington, DC (US)

(72) Inventors: Jim Santoianni, Washington, DC (US); Nicholas Narsavidze, Washington, DC (US)

(73) Assignee: REFACTURE, INC., Washington, DC (US)

(21) Appl. No.: 19/233,348

(22) Filed: Jun. 10, 2025

Related U.S. Application Data
(60) Provisional application No. 63/658,193, filed on Jun. 10, 2024.

(51) Int. Cl. A62D 3/19; A62D 101/08; A62D 101/45; C01B 32/949; C01B 32/97; C01B 32/991; C25C 7/06

(52) U.S. Cl. CPC A62D 3/19; C01B 32/949; C01B 32/97; C01B 32/991; C25C 7/06; A62D 2101/08; A62D 2101/45

(57) ABSTRACT

There is provided a method for separating an input feedstock using thermal plasma to obtain a processed feedstock and/or remove one or more hazardous compounds. There is also provided system for same comprising a plasma vortex reactor and a separator. There is also provided a method for forming a product from an input or processed feedstock using thermal plasma. There is also provided a system for same comprising a blender and a plasma rotary furnace.

### CROSS-REFERENCE TO RELATED APPLICATION

This application claims priority to and benefit of U.S. Patent Application Ser. No. 63/658,193 filed on Jun. 10, 2024.

### TECHNICAL FIELD

The present disclosure generally relates to methods and systems for separating an input feedstock using thermal plasma to obtain processed feedstock, critical materials, and products.

### BACKGROUND

Waste streams often contain valuable constituents including critical raw materials that are potentially rare or expensive to mine and or purify from their naturally occurring sources. One such example waste is spent potliner (SPL) generated in the primary aluminum industry. What is called the “first cut” SPL is the carbon cathode of the eletrolytic pot of the primary aluminum production process and is mostly carbon by weight. SPL is a problem due to the hazardous nature of the material. SPL contains cyanide and fluorine compounds. Generally, SPL is either landfilled, stored, or used in small amounts in cement kilns as a supplemental fuel.

The use of thermal technology for the processing of waste streams is known. In particular, oxidizing melters involving counter rotating vortex reactors are used to process SPL. However, several issues exist in relation to current oxidizing melter technologies that process waste streams. For example, when fed into current reactors or other uses of the waste, the heating value of carbon in SPL produces the heat necessary to melt the inorganic materials in SPL. While the fluorine in SPL can be processed for recovery and the melted inorganic can be used to generate a glass product, the carbon is not recovered but rather converted to carbon dioxide. Moreover, these technologies do not process or utilize the hazardous compounds that may be present in these waste streams. As a result, these hazardous compounds are often sent to landfills.

The use of thermal plasma technology for the processing of waste streams is known. Pyrolysis and/or gasification of wastes is a known application of thermal plasma for waste treatment, and particularly, treatment of municipal solid waste. In this application, organic material is converted to syngas and inorganic materials are vitrified into glass or slag. Typically, partial combustion of some fraction of the waste occurs. However, there are issues similar to those for the oxidizer melter technologies. At least some of the critical raw materials are thermally destroyed via thermal plasma. Even when there are critical raw materials that are not thermally destroyed in the thermal plasma process, current technologies may not be equipped to recover these critical raw materials. These unrecovered critical raw materials as well as any hazardous compounds present in the waste may be sent to landfills. If recovered, these critical raw materials could be used as virgin products or feedstocks to form further products.

A need therefore exists for improved methods for processing feedstocks using thermal plasma that recovers critical raw materials and/or removes hazardous compounds from these feedstocks.

### SUMMARY

The present disclosure provides methods and systems for separating an input feedstock using thermal plasma. The present disclosure recognizes that there are problems in the current existing thermal plasma technologies in respect of the recovery of critical raw materials, processed feedstocks, and products, and the removal of hazardous compounds.

An advantage of the present disclosure is the provision of methods and systems for separating an input feedstock using thermal plasma over existing technologies.

In some embodiments, the present disclosure relates to a method for separating an input feedstock using thermal plasma technology to obtain a processed feedstock and/or remove one or more hazardous compounds, the method comprising the steps of: providing the input feedstock to a plasma vortex reactor; applying plasma to the plasma vortex reactor to heat the input feedstock and form a heated feedstock; and separating the input feedstock into at least one of a liquid phase, a solid phase, and a gas phase to obtain the processed feedstock and/or remove the one or more hazardous compounds separated from other substances of the heated feedstock.

In some embodiments, the present disclosure relates to a method for recovering one or more critical raw materials and/or removing one or more hazardous compounds separating from a spent potliner using thermal plasma, the method comprising the steps of: providing the spent potliner to a plasma vortex reactor; applying plasma to the plasma vortex reactor to heat the spent potliner and form a heated spent potliner and remove at least one of the one or more hazardous compounds; separating the heated spent potliner into a liquid phase, a solid phase, and a gas phase to recover a first of the one or more critical raw materials separated from other substances from the solid phase; and treating the gas phase to further recover a second of the one or more critical raw materials; wherein the one or more critical raw materials comprises carbon and fluoride and the one or more hazardous compounds comprises cyanide.

In some embodiments, the present disclosure relates to a method for producing a product using thermal plasma, the method comprising the steps of: mixing an input feedstock and one or more additional feedstocks to form a mixed feedstock; delivering the mixed feedstock to a plasma rotary furnace; applying plasma to the plasma rotary furnace to heat the mixed feedstock and form the product; and recovering the product.

In some embodiments, the present disclosure relates to a system for separating an input feedstock using thermal plasma to obtain a processed feedstock and/or remove one or more hazardous compounds, the system comprising: a plasma vortex reactor for heating the input feedstock to a heated feedstock, the plasma vortex reactor comprising two or more plasma torches; and a separator operationally connected to the plasma vortex reactor, the separator for separating the heated feedstock into at least one of a liquid phase, a solid phase, and a gas phase for obtaining the processed feedstock and/or removing the one or more hazardous compounds.

In some embodiments, the present disclosure relates to a system for recovering one or more critical raw materials and/or remove one or more hazardous compounds from a spent potliner using thermal plasma, the system comprising: a plasma vortex reactor for heating the spent potliner to a heated spent potliner and removing the one or more hazardous compounds, the plasma vortex reactor comprising two or more plasma torches; a separator operationally connected to the plasma vortex reactor, the separator for separating the heated spent potliner into a liquid phase, a solid phase, and a gas phase, and obtaining a first of the one or more critical raw materials from the solid phase; and a treatment assembly operationally connected to the separator, the treatment assembly for treating the gas phase to obtain a second of the one or more critical raw materials; wherein the one or more critical raw materials comprises carbon and fluoride and the one or more hazardous compounds comprises cyanide.

Other aspects and embodiments of the disclosure are evident in view of the detailed description provided herein.

### BRIEF DESCRIPTION OF THE DRAWINGS

Further advantages, permutations and combinations of the invention will now appear from the above and from the following detailed description of the various particular embodiments of the invention taken together with the accompanying drawings, each of which are intended to be non limiting, in which:

FIG. 1 is a flowchart showing the steps of an exemplary method for separating an input feedstock using thermal plasma to obtain one or more critical raw materials and/or remove one or more hazardous compounds, according to some embodiments of the present disclosure;

FIG. 2 is a flowchart showing the steps of an exemplary method for forming a product using thermal plasma, according to some embodiments of the present disclosure;

FIG. 3 is a flowchart showing an exemplary method combining the steps shown in FIGS. 1 and 2 for processing an input feedstock using thermal plasma, according to some embodiments of the present disclosure;

FIG. 4 is a flowchart showing the steps of an exemplary method for recovering one or more critical raw materials and/or removing one or more hazardous compounds separating from a spent potliner using thermal plasma, according to some embodiments of the present disclosure;

FIG. 5 is a block diagram showing an exemplary system for separating an input feedstock using thermal plasma comprising a plasma vortex reactor and a separator, where the separator is positioned within the plasma vortex reactor;

FIG. 6 is a block diagram showing an exemplary system for separating an input feedstock using thermal plasma comprising a plasma vortex reactor and a separator, where the separator is positioned external to the plasma vortex reactor;

FIG. 7 is a block diagram showing an exemplary system for separating and treating an input feedstock using thermal plasma comprising a plasma vortex reactor, a separator, and a treatment assembly, where the separator is positioned within the plasma vortex reactor;

FIG. 8 is a block diagram showing an exemplary system for separating and treating an input feedstock using thermal plasma comprising a plasma vortex reactor, a separator, and a treatment assembly, where the separator is positioned external to the plasma vortex reactor;

FIG. 9 is a block diagram showing an exemplary system for processing an input feedstock to form a product using thermal plasma comprising a blender and a plasma rotary furnace;

FIG. 10 is a block diagram showing an exemplary system for processing an input feedstock to form a product using thermal plasma comprising a treatment assembly, a blender, and a plasma rotary furnace;

FIG. 11 is a block diagram showing an exemplary system for separating and processing an input feedstock to form a product using thermal plasma comprising a plasma vortex reactor, a separator, a blender, and a plasma rotary furnace, where the separator is positioned within the plasma vortex reactor;

FIG. 12 is a block diagram showing an exemplary system for separating and processing an input feedstock to form a product using thermal plasma comprising a plasma vortex reactor, a separator, a blender, and a plasma rotary furnace, where the separator is positioned external to the plasma vortex reactor;

FIG. 13 is a block diagram showing an exemplary system for separating and processing an input feedstock to form a product using thermal plasma comprising a plasma vortex reactor, a separator, a blender, a plasma rotary furnace, a treatment assembly, a cooling apparatus, and a processing assembly, where the separator is positioned within the plasma vortex reactor;

FIG. 14 is a block diagram showing an exemplary system for separating and processing an input feedstock to form a product using thermal plasma comprising a plasma vortex reactor, a separator, a blender, a plasma rotary furnace, a treatment assembly, a cooling apparatus, and a processing assembly, where the separator is positioned external to the plasma vortex reactor;

FIG. 15 is a flowchart showing an exemplary operation pattern for a system for processing an input feedstock using thermal plasma to obtain a product, according to some embodiments of the present disclosure;

FIG. 16 is a flowchart showing an exemplary operation pattern for a system for separating an input feedstock using thermal plasma to recover a product, according to some embodiments of the present disclosure;

FIG. 17 is a flowchart showing an exemplary operation pattern for a system for separating an input feedstock using thermal plasma to obtain a processed feedstock, according to some embodiments of the present disclosure;

FIG. 18 is a flowchart showing an exemplary operation pattern for a system for forming a product from an input or processed feedstock using thermal plasma, according to some embodiments of the present disclosure;

FIG. 19 is a flowchart showing an exemplary operation pattern for a system for separating a spent potliner using thermal plasma to obtain one or more critical raw materials and/or remove one or more hazardous compounds, according to some embodiments of the present disclosure; and

FIG. 20 is a flowchart showing an exemplary operation pattern for a system for forming a silicon carbide product from purified spent potliner carbon using thermal plasma, according to some embodiments of the present disclosure.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the suitable methods and materials are described below.

Waste stream processing methods and systems that use thermal plasma can be used to separate the waste streams into a liquid phase, a gas phase, and a solid phase. These separate phases allow for the recovery of critical raw materials and/or the removal of hazardous compounds, thereby providing for recycling of waste stream components for reuse as virgin products or as a feed component in the production of other products as well as removal/destruction of hazardous materials that would otherwise be sent to landfills. A method or system for processing a waste feedstock using thermal plasma is desired to provide a sustainable, environmentally friendly, and value-adding way of processing waste streams.

The embodiments of the present disclosure pertain to methods and systems for separating an input feedstock using thermal plasma. The input feedstock may comprise a waste feedstock. Methods and systems of the present disclosure advantageously provide for recovery of a processed feedstock and one or more critical raw materials and/or removal of one or more hazardous compounds, where the processed feedstock may be used to form a product.

The present disclosure provides a number of advantages over existing technologies. More particularly, the present disclosure provides improved methods and systems for processing waste streams that, for example, allow for recovery of processed feedstocks and critical raw materials and removal of hazardous compounds, and potentially for forming a product from the processed feedstock.

An advantage of the present disclosure is the provision of thermal plasma with a plasma vortex reactor to separate an input feedstock into at least one of a liquid phase, a solid phase, and a gas phase for recovery of the processed feedstock and the one or more critical raw materials and/or removal of the one or more hazardous compounds from the liquid phase, the solid phase, and/or the gas phase. In instances where the input feedstock comprises a waste feedstock from a waste stream, this ensures a comprehensive processing of the waste feedstock such that multiple constituents of the waste feedstock may be processed in an environmentally friendly manner.

Another advantage of the present disclosure is the provision of thermal plasma with a plasma rotary furnace for the formation of a product from the processed feedstock. The use of a plasma rotary furnace for formation of the product coupled with a plasma vortex reactor for separation of the input feedstock may advantageously allow for continuous mode recovery/production of the product as opposed to traditional batch mode recovery/production of products.

In some embodiments, the present disclosure relates to a method for separating an input feedstock using thermal plasma technology to obtain a processed feedstock and/or remove one or more hazardous compounds, the method comprising the steps of: providing the input feedstock to a plasma vortex reactor; applying plasma to the plasma vortex reactor to heat the input feedstock and form a heated feedstock; and separating the input feedstock into at least one of a liquid phase, a solid phase, and a gas phase to obtain the processed feedstock and/or remove the one or more hazardous compounds separated from other substances of the heated feedstock.

As used herein, the term “input feedstock” refers to any material or substance that may be broken down or separated into one or more constituents. In some embodiments, the input feedstock comprises spent potliner, petcoke, carbon black, mine tailings, bauxite tailings and residue, industrial sludges, the like, or any combination thereof. In some embodiments, the input feedstock comprises carbon. In some embodiments, the input feedstock is a waste feedstock. As used herein, the term “waste stream” refers to any by-product of industrial processes, mining processes, manufacturing processes, and the like. The term “waste stream” comprises or can be used interchangeably with “waste feedstock”. In some embodiments, the waste feedstock is a hazardous waste feedstock.

In some embodiments, the method comprises steps for separating a waste feedstock using thermal plasma to obtain one or more critical raw materials and/or remove one or more hazardous compounds, the method comprising the steps of: providing the waste feedstock to a plasma vortex reactor; applying plasma to the plasma vortex reactor to heat the waste feedstock and form a heated feedstock; and separating the heated feedstock into at least one of a liquid phase, a solid phase, and a gas phase to obtain the one or more critical raw materials and/or remove the one or more hazardous compounds separated from other substances of the heated feedstock.

As used herein, the term “critical raw materials” refers to any input feedstock constituent that may be used, after separation from other input feedstock constituents, as virgin products or as a feed component in the production of other products. The term “critical raw materials” may, in some instances, be used interchangeably with the terms “virgin product”, “processed feedstock”, and/or “condensed solids”. Critical raw materials may, for example and without limitation, include metals, minerals and natural materials. In some embodiments, the one or more critical raw materials comprises natural and synthetic graphite, nickel, helium, niobium, gallium, manganese, titanium, platinum group metals, heavy rare earth elements, germanium, antimony, phosphorus, feldspar, silicon, cobalt, arsenic, aluminum, coking coal, fluorspar, phosphate, magnesium, scandium, lithium, light rare earth element, tantalum, vanadium, tungsten, hafnium, strontium, barite, bismuth, boron, beryllium, copper, or any combination thereof. In some embodiments, the one or more critical raw materials comprises carbon, fluorine, cryolite, or any combination thereof.

As used herein, the term “hazardous compounds” refers to any input feedstock constituent that may be lethal or pose some danger to an exposed person. Hazardous compounds may, for example and without limitation, be flammable and combustible, oxidizing, poisonous and infectious, corrosive, dangerously reactive, radioactive, or any combination thereof. In some embodiments, the one or more hazardous compounds comprises cyanide.

As used herein, the term “other substances of the heated feedstock” refers to any constituent of the heated feedstock other than the one or more critical raw materials and/or the one or more hazardous compounds. In some embodiments, the other substances of the heated feedstock comprise inorganic species.

As used herein, the term “plasma vortex reactor” or PVR refers to any apparatus, instrument, device, chamber, compartment, system, or assembly that utilizes two or more plasma discharges to create a plasma vortex from opposing swirls of plasma. Without being limited by any particular theory, a plasma vortex may apply high shear forces to an incoming waste feedstock flow which results in rapid heating of the waste feedstock due to a high convective component of heat transfer as well as a high radiative heat transfer from the plasma plumes.

As used herein, the term “reaction chamber” in relation to either or both of a plasma vortex reactor and a plasma rotary furnace refers to any space, void, or area contained therein that receives a directed flow of plasma and a feedstock. In some embodiments, the reaction chamber may also receive one or more additional feedstocks and/or gases. The term “reaction chamber” may be used interchangeably with the term “plasma heating channel”.

In some embodiments, the plasma is delivered to a reaction compartment of the plasma vortex reactor by two or more plasma torches. In some embodiments, the two or more plasma torches are positioned tangentially at two or more different flow planes for forming two or more tangential plasma vortices having different directions within the plasma vortex reactor. In some embodiments, at least two of the two or more plasma torches are positioned tangentially at two different flow planes for forming counter rotating tangential plasma vortices within the plasma vortex reactor.

As used herein, the term “plasma torch” refers to a device for generating a directed flow of plasma. The term “plasma torch” may be used interchangeably with “plasma arc”, “plasma gun”, “plasma cutter”, and/or “plasmatron”. In some embodiments, the two or more plasma torches and the one or more plasma torches comprises a non-transferred arc plasma torch.

As used herein, the term “flow planes” refers to the path, area, or level of a discharge from a plasma torch. In some embodiments, the different flow planes comprise having the two or more plasma torches at two or more different positions along the horizontal axis and/or the vertical axis within the plasma vortex reactor. Without being bound by any particular theory, the different flow planes of the plasma torches correspond to the tangential positioning such that high shear forces of the plasma vortex are created from the discharges of the plasma torches.

In some embodiments, the step of applying plasma to the plasma vortex reactor comprises torch operation on any gas suitable for plasma. In some embodiments, the step of applying plasma to the plasma vortex reactor comprises torch operation on nitrogen, oxygen, carbon dioxide, carbon monoxide, argon, hydrogen, helium, air, or any combination thereof. In some embodiments, the step of applying plasma to the plasma vortex reactor comprises torch operation on either or both of argon and hydrogen. In some embodiments, the step of applying plasma to the plasma vortex reactor comprises torch operation on argon and hydrogen.

In some embodiments, the step of applying plasma comprises heating an interior of the plasma vortex reactor to about 2,000° C., about 2,500° C., about 3,000° C., about 3,500° C., about 4,000° C., about 4,500° C., about 5,000° C., about 5,500° C., or about 6,000° C. In some embodiments, the step of applying plasma comprises heating an interior of the plasma vortex reactor to about 3,000° C.

In some embodiments, the method further comprises a step of treating the at least one of a liquid phase, the solid phase, and the gas phase to obtain one or more critical raw materials and/or remove another of the one or more hazardous compounds separated from the other substances.

In some embodiments, the step of separating the heated feedstock comprises separating the heated feedstock into a liquid phase, a solid phase, and a gas phase. In some embodiments, the step of separating the heated feedstock comprises inputting the heated feedstock into a separator. As used herein, the term “separator” refers to any apparatus, assembly, instrument, or system that can convert a material or feedstock into a constituent gas, a constituent liquid, a constituent solid, or any combination thereof. In some embodiments, the separator comprises a horizontal separator, a vertical separator, or a spherical separator. In some embodiments, the separator comprises a hot cyclone.

In some embodiments, the method further comprises a step of processing the input feedstock prior to the step of providing the waste feedstock to a plasma vortex reactor. In some embodiments, the step of processing comprises reducing a particle size of the input feedstock to a desired particle size. In some embodiments, the desired particle size comprises a particle size less than about 2 mm. In some embodiments, the desired particle size comprises a particle size of about 2 mm, about 1.5 mm, about 1 mm, about 0.5 mm, about 0.1 mm, about 0.08 mm, about 0.06 mm, about 0.04 mm, about 0.02 mm, or about 0.01 mm. In some embodiments, the desired particle size comprises a particle size about 0.02 mm. In some embodiments, the desired particle size comprises a particle size less than about 0.02 mm.

In some embodiments, the step of separating the heated feedstock comprises recovering the carbon as the processed feedstock and/or the one or more critical raw materials.

In some embodiments, the step of applying plasma to the plasma vortex reactor comprises: pyrolyzing one or more substances of the input feedstock; vitrifying the one or more substances of the input feedstock; thermally destroying the one or more substances of the input feedstock; liquifying the one or more substances of the input feedstock; volatilizing the one or more substances of the input feedstock; or any combination thereof.

As used herein, the term “one or more substances of the input feedstock” refers to any constituent of the input feedstock including, but not limited to, the processed feedstock, the one or more critical raw materials, and the one or more hazardous compounds.

In some embodiments, the step of applying heat excludes intake into or heating of oxygen. In some embodiments, the plasma vortex reactor is devoid of any oxygen.

In some embodiments, the steps of the methods disclosed herein are performed under vacuum or near vacuum conditions. In some embodiments, near vacuum conditions comprise a pressure of about 0.1 Pa. In some embodiments, near vacuum conditions comprise any pressure that is above 0 Pa and below 0.1 Pa.

In some embodiments, the method further comprises the steps of: mixing a processed feedstock and one or more additional feedstocks to form a mixed feedstock; delivering the mixed feedstock to a plasma rotary furnace; applying plasma to the plasma rotary furnace to heat the mixed feedstock and form the product; and recovering the product.

As used herein, the term “plasma rotary furnace” refers to any apparatus, instrument, device, chamber, compartment, system, or assembly that utilizes one or more plasma discharges for heating within a rotating and/or tilted enclosure.

In some embodiments, the step of applying plasma to the plasma rotary furnace comprises heating an interior of the plasma rotary furnace to a temperature of about 2,000° C., about 2,500° C., about 3,000° C., about 3,500° C., about 4,000° C., about 4,500° C., about 5,000° C., about 5,500° C., or about 6,000° C. In some embodiments, the step of applying plasma to the plasma rotary furnace comprises heating an interior of the plasma rotary furnace to a temperature of about 2,500° C.

In some embodiments, the plasma is delivered to a reaction compartment of the plasma rotary furnace by one or more plasma torches. In some embodiments, the step of applying plasma to the plasma rotary furnace comprises torch operation on any gas suitable for plasma. In some embodiments, the step of applying plasma to the plasma rotary furnace comprises torch operation on nitrogen, oxygen, carbon dioxide, argon, hydrogen, helium, air, or any combination thereof. In some embodiments, the step of applying plasma to the plasma rotary furnace comprises torch operation on either or both of argon and hydrogen.

As used herein, the term “processed feedstock” may also refer to an input feedstock that has undergone heating in a plasma vortex reactor and no longer comprises one of the one or more critical raw materials and/or one of the one or more hazardous compounds. The processed feedstock may be a purified feedstock wherein undesirable elements, components, or impurities have been removed from the input feedstock. For example, and without limitation, the processed feedstock may contain a higher purity or a higher weight percentage of carbon relative to the input feedstock. In some embodiments, the step of separating the heated feedstock comprises recovering the carbon as the processed feedstock. In some embodiments, the processed feedstock comprises purified carbon, purified spent potliner, and/or the like.

As used herein, the term “product” refers to any material, substance, product, compound, or composition that may be formed from thermal plasma processing via plasma rotary furnace of the input or processed feedstock. The product may be a form of the input feedstock or processed feedstock that contains a higher purity or a higher weight amount of a desirable component or element. For example, and without limitation, the product may contain a higher weight percentage of carbon relative to the input feedstock and the processed feedstock. In some embodiments, the product comprises critical elements including, but not limited to, oxides and/or metals. In some embodiments, the product comprises silicon carbide, tungsten carbide, boron carbide, the like, or any combination thereof.

In some embodiments, the method further comprises a step of processing the processed feedstock prior to the step of mixing the processed feedstock and the one or more additional feedstocks. In some embodiments, the step of processing comprises reducing a particle size of the processed feedstock to a desired particle size. Without being bound by any particular theory, the desired particle size may be dependent on the type of product.

In some embodiments, the one or more additional feedstocks comprise either or both of a binder and one or more further components. In some embodiments, the one or more further components comprises a mineral, a metal, a plant material, a plastic, a gas, a liquid, or any combination thereof. In some embodiments, the one or more further components comprises quartz, boron, tungsten, the like, or any combination thereof. In some embodiments, the mixed feedstock comprises an agglomerate.

In some embodiments, the step of recovering the product comprises a continuous mode recovery of the product. As used herein, the term “continuous mode recovery” refers to a continuous stream/production of the product from the plasma rotary furnace with no downtime between outputs of the product. Without being bound by any particular theory, continuous input of feedstock and operation of the plasma rotary furnace may facilitate the continuous mode recovery of the product.

In some embodiments, the present disclosure relates to a method for producing a product using thermal plasma, the method comprising the steps of: mixing an input feedstock and a secondary feedstock to form a mixed feedstock; delivering the mixed feedstock to a plasma rotary furnace; applying plasma to the plasma rotary furnace to heat the mixed feedstock and form the product; and recovering the product.

In some embodiments, the present disclosure relates to a method for recovering one or more critical raw materials and/or removing one or more hazardous compounds separating from a spent potliner using thermal plasma, the method comprising the steps of: providing the spent potliner to a plasma vortex reactor; applying plasma to the plasma vortex reactor to heat the spent potliner and form a heated spent potliner and remove at least one of the one or more hazardous compounds; separating the heated spent potliner into a liquid phase, a solid phase, and a gas phase to recover a first of the one or more critical raw materials separated from other substances from the solid phase; and treating the gas phase to recover a second of the one or more critical raw materials; wherein the one or more critical raw materials comprises carbon and fluoride and the one or more hazardous compounds comprises cyanide.

As used herein, the term “spent potliner” refers to a waste material generated in the primary aluminum industry. In some embodiments, the spent potliner comprises a first cut spent potliner. As used herein, the term “first cut spent potliner” comprises a carbon cathode lining of an aluminum pot. In some embodiments, the first cut spent potliner comprises over about 50% carbon by weight.

In some embodiments, the method further comprises a step of processing the spent potliner prior to the step of providing the spent potliner to a plasma vortex reactor. In some embodiments, the step of processing comprises reducing a particle size of the spent potliner to a desired particle size. In some embodiments, the desired particle size comprises a particle size less than about 2 mm. In some embodiments, the desired particle size comprises a particle size of about 2 mm, about 1.5 mm, about 1 mm, about 0.5 mm, about 0.1 mm, about 0.08 mm, about 0.06 mm, about 0.04 mm, about 0.02 mm, or about 0.01 mm. In some embodiments, the desired particle size comprises a particle size about 0.02 mm. Without being bound by any particular theory, the desired particle size facilitates even and rapid heating of the spent potliner by the plasma vortex reactor for separation into the solid phase, the liquid phase, and the gas phase.

In some embodiments, the step of separating the heated spent potliner comprises recovering carbon from the solid phase as the first of the one or more critical raw materials.

In some embodiments, the step of treating the gas phase comprises injecting alumina powder into the gas phase to obtain fluoride as the second of the one or more critical raw materials. In some embodiments, the fluoride comprises aluminum fluoride. In some embodiments, the fluoride comprises cryolite. Without being bound by any particular theory, aluminum fluoride may be produced under oxidizing conditions while cryolite may be produced under reducing conditions.

In some embodiments, the step of applying plasma to the plasma vortex reactor comprises: pyrolyzing one or more substances of the spent potliner; vitrifying the one or more substances of the spent potliner; thermally destroying the one or more substances of the spent potliner; liquifying the one or more substances of the spent potliner; volatilizing the one or more substances of the spent potliner; or any combination thereof. In some embodiments, the step of applying plasma to the plasma vortex reactor comprises: vitrifying inorganic species of the spent potliner; thermally destroying the cyanide of the spent potliner; volatilizing the fluoride of the spent potliner; or any combination thereof. In some embodiments, the liquid phase comprises the inorganic species.

In some embodiments, the first of the one or more critical raw materials is a purified spent potliner that comprises the carbon. As used herein, the term “purified spent potliner” refers to a spent potliner that has undergone thermal plasma heating in a plasma vortex reactor and no longer comprises at least one or both of fluorine and cyanide.

In some embodiments, the method further comprises steps of: mixing the purified spent potliner and one or more additional feedstocks to form an agglomerated carbon silica; delivering the agglomerated carbon silica to a plasma rotary furnace; applying plasma to the plasma rotary furnace to heat the agglomerated carbon silica and form silicon carbide; and recovering the silicon carbide.

In some embodiments, the one or more additional feedstocks comprise quartz and optionally a binder. In some embodiments, the binder comprises a wax, a starch, a latex, a plastic, or any combination thereof.

In some embodiments, the step of recovering the silicon carbide is a continuous mode recovery of the silicon carbide. In some embodiments, the silicon carbide comprises a C:Si mole ratio from about 2 to about 4.

In some embodiments, the present disclosure relates to a system for separating an input feedstock using thermal plasma to obtain a processed feedstock and/or remove one or more hazardous compounds, the system comprising: a plasma vortex reactor for heating the waste feedstock to a heated feedstock, the plasma vortex reactor comprising two or more plasma torches; and a separator operationally connected to the plasma vortex reactor, the separator for separating the heated feedstock into at least one of a liquid phase, a solid phase, and a gas phase for obtaining the processed feedstock and/or removing the one or more hazardous compounds.

In some embodiments, the system further comprises a treatment assembly operationally connected to the separator and/or the plasma vortex reactor, the treatment assembly for treating the at least one of a liquid phase, the solid phase, and the gas phase to obtain one or more critical raw materials and/or remove another of the one or more hazardous compounds separated from the other substances. In some embodiments, the treatment assembly comprises a centrifuge, a filter, a cooling apparatus, a heating apparatus, an injector, a vaporizer, the like, or any combination thereof.

In some embodiments, the system further comprises a processing assembly operationally connected to the plasma vortex reactor, the processing assembly for processing the input feedstock. In some embodiments, the processing assembly comprises a sizing apparatus for reducing a particle size of the input feedstock to a desired particle size. In some embodiments, the processing assembly comprises a cutting apparatus, a grinding apparatus, the like, or any combination thereof.

In some embodiments, in operation, an interior of the plasma vortex reactor reaches a temperature of about 2,000° C., about 2,500° C., about 3,000° C., about 3,500° C., about 4,000° C., about 4,500° C., about 5,000° C., about 5,500° C., or about 6,000° C. In some embodiments, in operation, an interior of the plasma vortex reactor reaches a temperature of about 3,000° C.

In some embodiments, the two or more plasma torches are positioned tangentially at two or more different flow planes for forming two or more tangential plasma vortices having different directions within the plasma vortex reactor. In some embodiments, at least two of the two or more plasma torches are positioned tangentially at two different flow planes for forming counter rotating tangential plasma vortices within the plasma vortex reactor.

In some embodiments, the two or more plasma torches operate on any gas suitable for plasma. In some embodiments, the two or more plasma torches operate on nitrogen, oxygen, carbon dioxide, argon, hydrogen, helium, air, or any combination thereof. In some embodiments, the two or more plasma torches operate on either or both of argon and hydrogen.

In some embodiments, the plasma vortex reactor is oriented horizontally. Without being bound by any particular theory, horizontal orientation of the plasma vortex reactor may facilitate the conversion of the input feedstock into a liquid phase, a solid phase, and a gas phase by allowing differential movement of each of the liquid phase, the solid phase, and the gas phase.

In some embodiments, either or both of the plasma vortex reactor and the separator comprises a channel for receivably conveying a liquid phase.

In some embodiments, the system further comprises a processing assembly operationally connected to the plasma vortex reactor, the processing assembly for reducing a particle size of the input feedstock to a desired particle size.

In some embodiments, the system further comprises a cooling apparatus for water cooling either or both of the plasma vortex reactor and the treatment assembly.

In some embodiments, the system further comprises: a blender operationally connected to the separator for agglomerating the processed feedstock with one or more additional feedstocks to form a mixed feedstock; a plasma rotary furnace operationally connected to the blender for heating the mixed feedstock and forming a product, the plasma rotary furnace comprising one or more plasma torches.

In some embodiments, in operation, an interior of the plasma rotary furnace reaches a temperature of about 2,500° C.

In some embodiments, in operation, an interior of the plasma rotary furnace reaches a temperature of about 2,000° C., about 2,500° C., about 3,000° C., about 3,500° C., about 4,000° C., about 4,500° C., about 5,000° C., about 5,500° C., or about 6,000° C. In some embodiments, in operation, an interior of the plasma rotary furnace reaches a temperature of about 2,500° C.

In some embodiments, the plasma is delivered to a reaction compartment of the plasma rotary furnace by one or more plasma torches. In some embodiments, the step of applying plasma to the plasma rotary furnace comprises torch operation on any gas suitable for plasma. In some embodiments, the step of applying plasma to the plasma rotary furnace comprises torch operation on nitrogen, oxygen, carbon dioxide, argon, hydrogen, helium, air, or any combination thereof. In some embodiments, the step of applying plasma to the plasma rotary furnace comprises torch operation on either or both of argon and hydrogen.

In some embodiments, the plasma rotary furnace comprises a continuous mode recovery of the product. In some embodiments, the plasma furnace comprises a product cooling and recovery assembly.

In some embodiments, the system further comprises one or more power supplies for powering the system. In some embodiments, the one or more power supplies comprises one or both of arc power and field power. In some embodiments, the plasma rotary furnace further comprises a thermal oxidizer.

In some embodiments, the present disclosure relates to a system for recovering one or more critical raw materials and/or remove one or more hazardous compounds from a spent potliner using thermal plasma, the system comprising: a plasma vortex reactor for heating the spent potliner to a heated spent potliner and removing the one or more hazardous compounds, the plasma vortex reactor comprising two or more plasma torches; a separator operationally connected to the plasma vortex reactor, the separator for separating the heated spent potliner into a liquid phase, a solid phase, and a gas phase, and obtaining a first of the one or more critical raw materials from the solid phase; and a treatment assembly operationally connected to the separator, the treatment assembly for treating the gas phase to obtain a second of the one or more critical raw materials; wherein the one or more critical raw materials comprises carbon and fluoride and the one or more hazardous compounds comprises cyanide.

In some embodiments, the first of the one or more critical raw materials comprises carbon. In some embodiments, the first of the one or more critical raw materials is a purified spent potliner that comprises carbon. In some embodiments, the second of the one or more critical raw materials comprises fluoride.

In some embodiments, the treatment assembly comprises a fluorine dry scrubbing system. In some embodiments, the treatment assembly comprises an injector and a filter. In some embodiments, the injector provides alumina powder to the gas phase. In some embodiments, the bagfilter collects aluminum fluoride.

In some embodiments, the system further comprises: a blender operationally connected to the separator for agglomerating the first of the one or more critical raw materials with a secondary feedstock to form an agglomerated carbon silica; a plasma rotary furnace operationally connected to the blender for heating the agglomerated carbon silica and forming silicon carbide, the plasma rotary furnace comprising one or more plasma torches.

Reference will now be made in detail to exemplary embodiments of the present disclosure, wherein numerals refer to like components, examples of which are illustrated in the accompanying drawings that further show exemplary embodiments, without limitation.

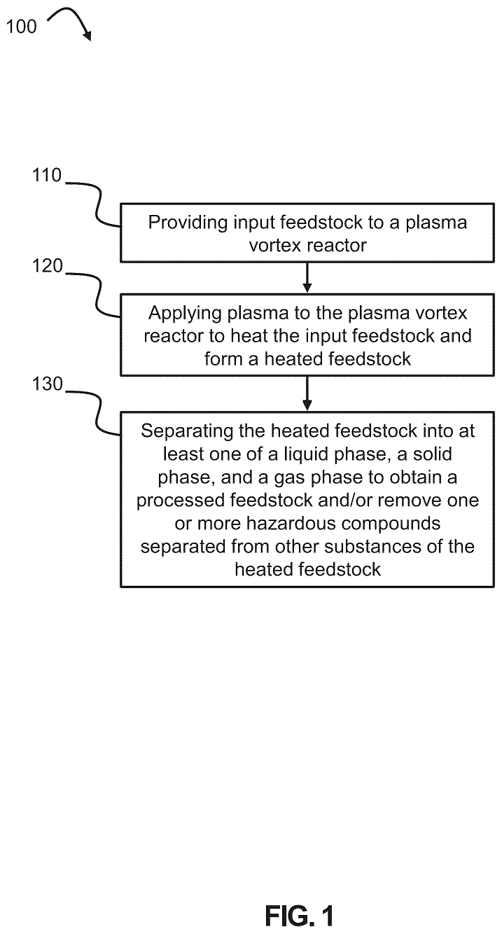

FIG. 1 illustrates the steps of an exemplary method 100 for separating an input feedstock using thermal plasma to obtain a processed feedstock and/or remove one or more hazardous compounds. In some embodiments, the method comprises: a step of providing 110 the input feedstock to a plasma vortex reactor; a step of applying 120 plasma to the plasma vortex reactor to heat the input feedstock and form a heated feedstock; and a step of separating 130 the heated feedstock into at least one of a liquid phase, a solid phase, and a gas phase to obtain the processed feedstock and/or remove the one or more hazardous compounds separated from other substances of the heated feedstock.

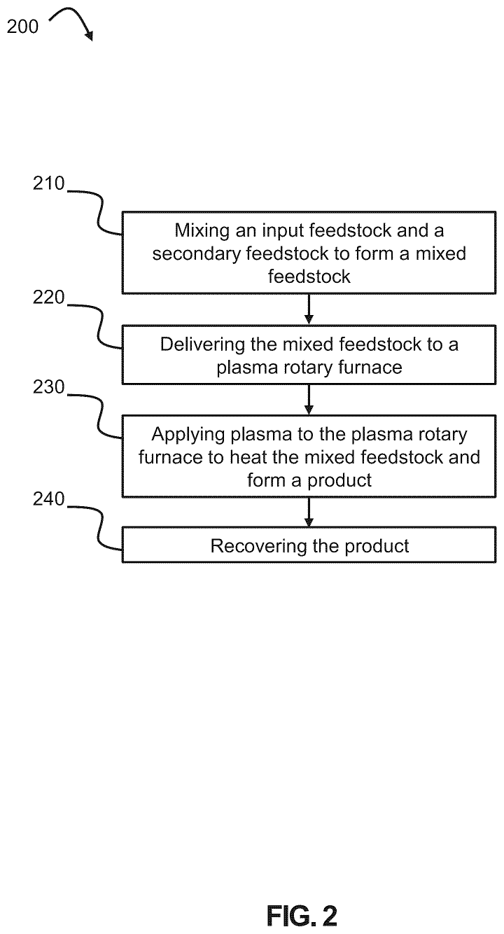

FIG. 2 illustrates the steps of an exemplary method 200 for producing a product using thermal plasma. In some embodiments, the method comprises: a step of mixing 210 an input feedstock and a secondary feedstock to form a mixed feedstock; a step of delivering 220 the mixed feedstock to a plasma rotary furnace; a step of applying 230 plasma to the plasma rotary furnace to heat the mixed feedstock and form the product; and a step of recovering 240 the product.

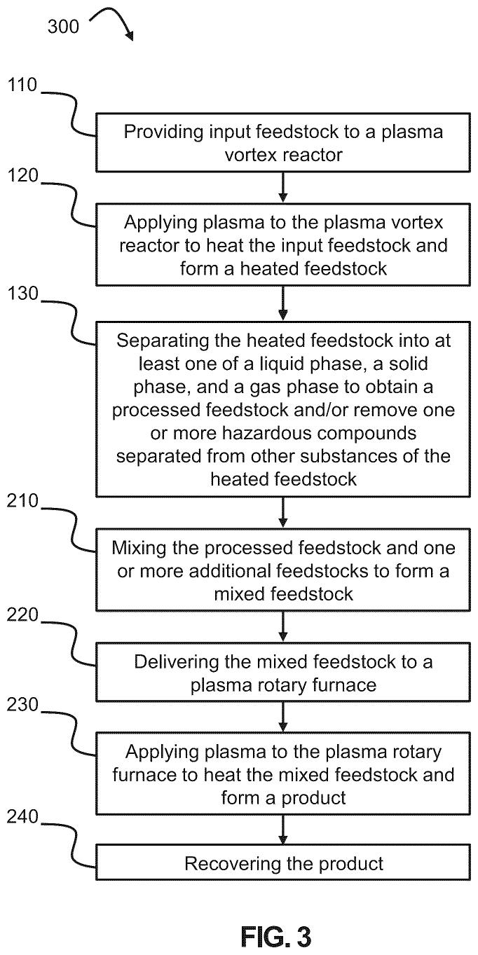

FIG. 3 illustrates the steps of an exemplary method 300 for processing a waste feedstock using thermal plasma, wherein method 300 being a combination of the steps of the method 100 shown in FIG. 1 and the steps of the method 200 shown in FIG. 2. The processed feedstock formed in step 130 is used as the input feedstock in the step of mixing 210. In some embodiments, the method comprises: a step of providing 110 the input feedstock to a plasma vortex reactor; a step of applying 120 plasma to the plasma vortex reactor to heat the input feedstock and form a heated feedstock; a step of separating 130 the heated feedstock into at least one of a liquid phase, a solid phase, and a gas phase to obtain a processed feedstock and/or remove one or more hazardous compounds separated from other substances; a step of mixing 210 the processed feedstock and one or more additional feedstocks to form a mixed feedstock; a step of delivering 220 the mixed feedstock to a plasma rotary furnace; a step of applying 230 plasma to the plasma rotary furnace to heat the mixed feedstock and form a product; and a step of recovering 240 the product.

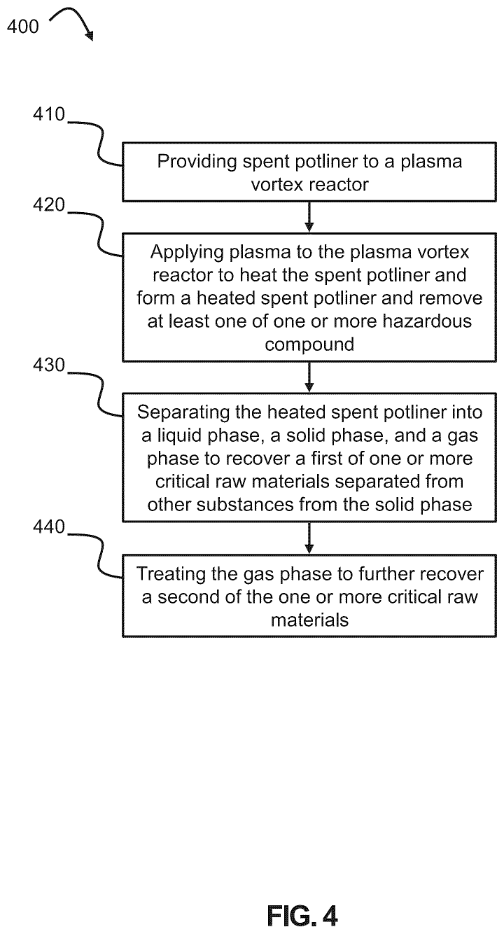

FIG. 4 illustrates the steps of an exemplary method 400 for recovering one or more critical raw materials and/or removing one or more hazardous compounds separating from a spent potliner using thermal plasma. In some embodiments, the method comprises: a step of providing 410 the spent potliner to a plasma vortex reactor; a step of applying 420 plasma to the plasma vortex reactor to heat the spent potliner and form a heated spent potliner and remove at least one of the one or more hazardous compounds; a step of separating 430 the heated spent potliner into a liquid phase, a solid phase, and a gas phase to recover a first of the one or more critical raw materials separated from other substances from the solid phase; and a step of treating 440 the gas phase to further recover a second of the one or more critical raw materials.

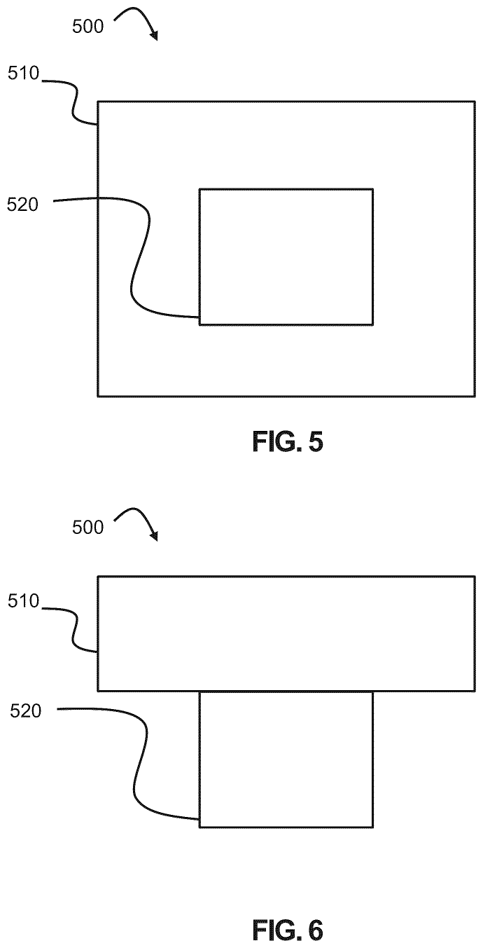

FIG. 5 illustrates an exemplary system 500 of the present disclosure comprising a plasma vortex reactor 510 and a separator 520. The plasma vortex reactor 510 receivably heats an input feedstock to a heated feedstock with two or more plasma torches (not shown). The separator 520 receives the heated feedstock to separate it into at least one of a liquid phase, a solid phase, and a gas phase for obtaining the processed feedstock and the one or more critical raw materials and/or removing the one or more hazardous compounds. The separator 520 is contained within the plasma vortex reactor 510.

FIG. 6 illustrates another embodiment of the system 500 shown in FIG. 5, wherein the separator 520 is external to the plasma vortex reactor 510.

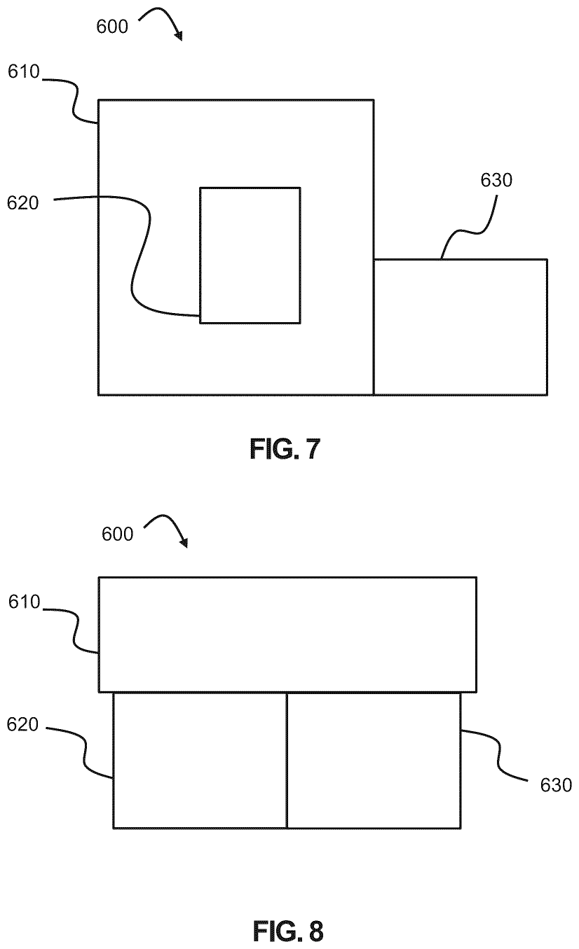

FIG. 7 illustrates an exemplary system 600 of the present disclosure comprising a plasma vortex reactor 610, a separator 620, and a treatment assembly 630. The system 600 is operationally similar to the system 500 shown in FIGS. 5 and 6 to obtain the processed feedstock and the one or more critical raw materials and/or remove the one or more hazardous compounds. However, in this system 600, the treatment assembly 630 then receivably treats the gas phase to obtain another one or more critical raw materials and/or remove another one or more hazardous compounds. The separator 620 is contained within the plasma vortex reactor 610.

FIG. 8 illustrates another embodiment of the system 600 shown in FIG. 6, wherein the separator 620 is external to the plasma vortex reactor 610. In both FIGS. 7 and 8, the treatment assembly 630 is external to the plasma vortex reactor 610.

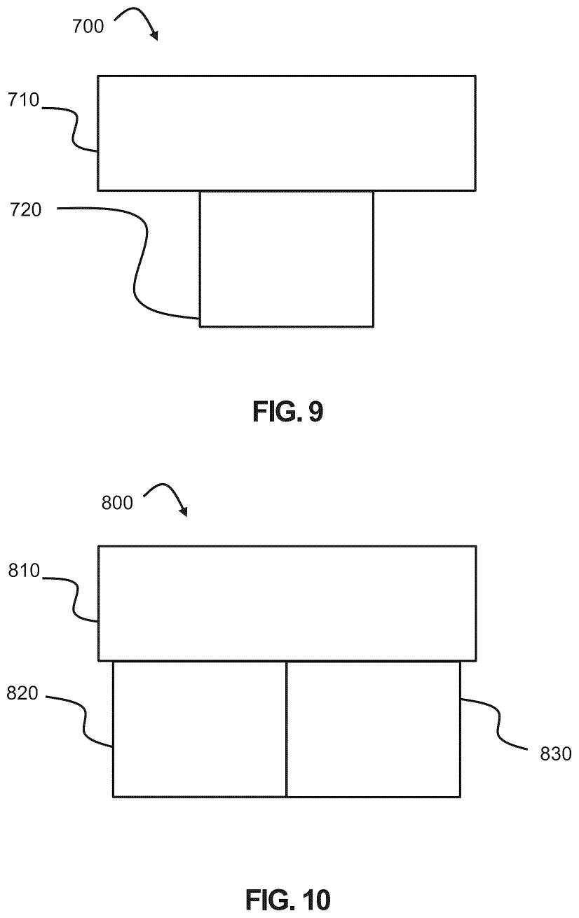

FIG. 9 illustrates an exemplary system 700 of the present disclosure comprising a blender 710 and a plasma rotary furnace 720. The blender 710 receivably agglomerates an input feedstock or a processed feedstock with one or more additional feedstocks to form a mixed feedstock. The plasma rotary furnace 720 receivably heats the mixed feedstock with one or more plasma torches (not shown) to form a product.

FIG. 10 illustrates an exemplary system 800 of the present disclosure comprising a blender 810, a plasma rotary furnace 820, and a treatment assembly 830. The system 800 is operationally similar to the system 700 shown in FIG. 9 to form the product. However, in this system 800, the treatment assembly 830 then receivably treats the product to obtain one or more critical raw materials and/or remove one or more hazardous compounds.

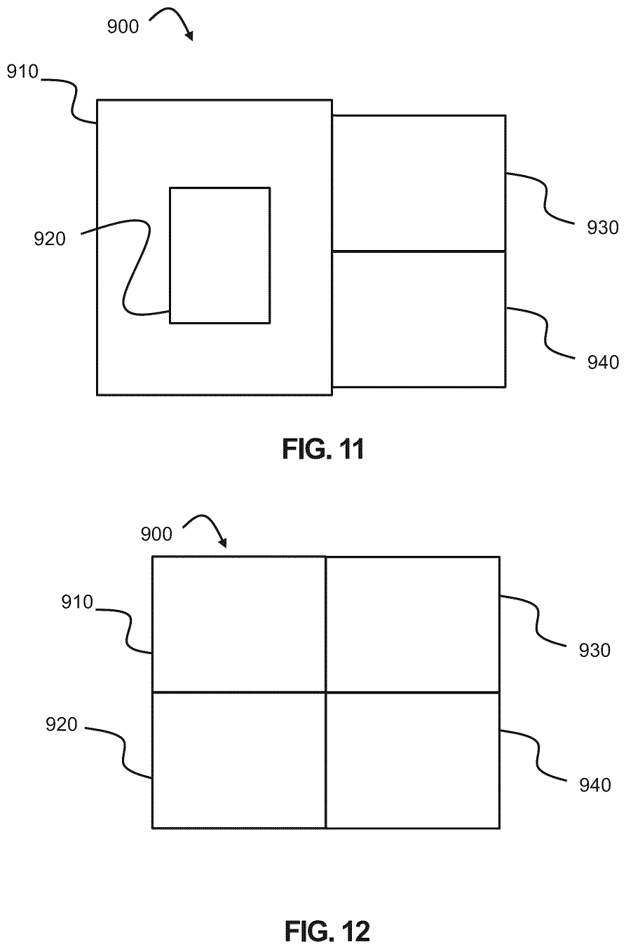

FIG. 11 illustrates an exemplary system 900 of the present disclosure comprising a plasma vortex reactor 910, a separator 920, a blender 930, and a plasma rotary furnace 940. The plasma vortex reactor 910 receivably heats an input feedstock to a heated feedstock with two or more plasma torches (not shown). The separator 920 receives the heated feedstock to separate it into at least one of a liquid phase, a solid phase, and a gas phase for obtaining the processed feedstock and the one or more critical raw materials and/or removing the one or more hazardous compounds. The separator 920 is contained within the plasma vortex reactor 910. The blender 930 receivably agglomerates the processed feedstock with one or more additional feedstocks to form a mixed feedstock. The plasma rotary furnace 940 receivably heats the mixed feedstock with one or more plasma torches (not shown) to form a product.

FIG. 12 illustrates another embodiment of the system 900 shown in FIG. 11, wherein the separator 920 is external to the plasma vortex reactor 910.

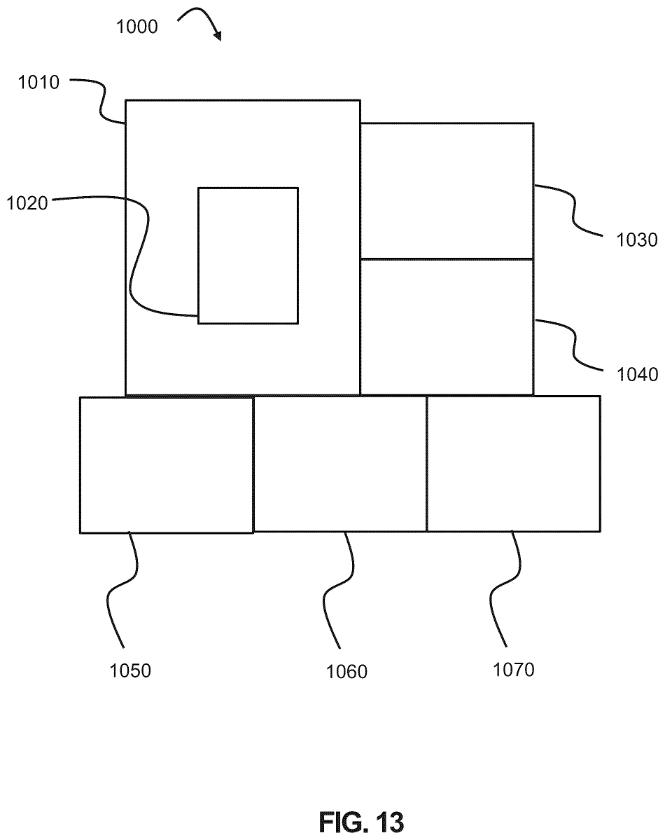

FIG. 13 illustrates an exemplary system 1000 of the present disclosure comprising a plasma vortex reactor 1010, a separator 1020, a blender 1030, a plasma rotary furnace 1040, a cooling apparatus 1050, a processing assembly 1060, and a treatment assembly 1070. The system 1000 is operationally similar to the system 900 shown in FIGS. 11 and 12 to form the product. However, each of the cooling apparatus 1050, the processing assembly 1060, and the treatment assembly 1070 carry out additional functions. The processing assembly 1060 receivably reduces the particle size of the input feedstock to a desired particle size before the input feedstock is received by the plasma vortex reactor 1010. The treatment assembly 830 receivably treats the processed feedstock and/or the product to obtain one or more critical raw materials and/or remove one or more hazardous compounds. The cooling apparatus 1050 is configured to cool the plasma vortex reactor 1010, the plasma rotary furnace 1040, and/or the treatment assembly 1070. The separator 1020 is contained within the plasma vortex reactor 1010.

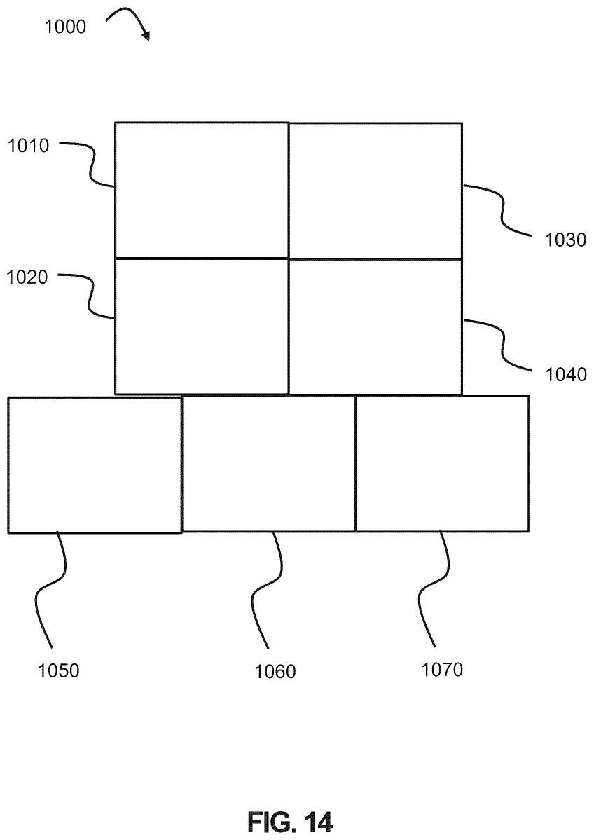

FIG. 14 illustrates another embodiment of the system 1000 shown in FIG. 13, wherein the separator 1020 is external to the plasma vortex reactor 1010.

A person skilled in the art will appreciate that, in each of the exemplary systems shown in FIGS. 5 to 14, further components, apparatuses, assemblies and system are contemplated as being contained therein. For example and without limitation, power assemblies, batteries, computing systems, systems for automated operation, artificial intelligence, the like, and any combination thereof may be included in each of the exemplary systems to facilitate operation thereof.

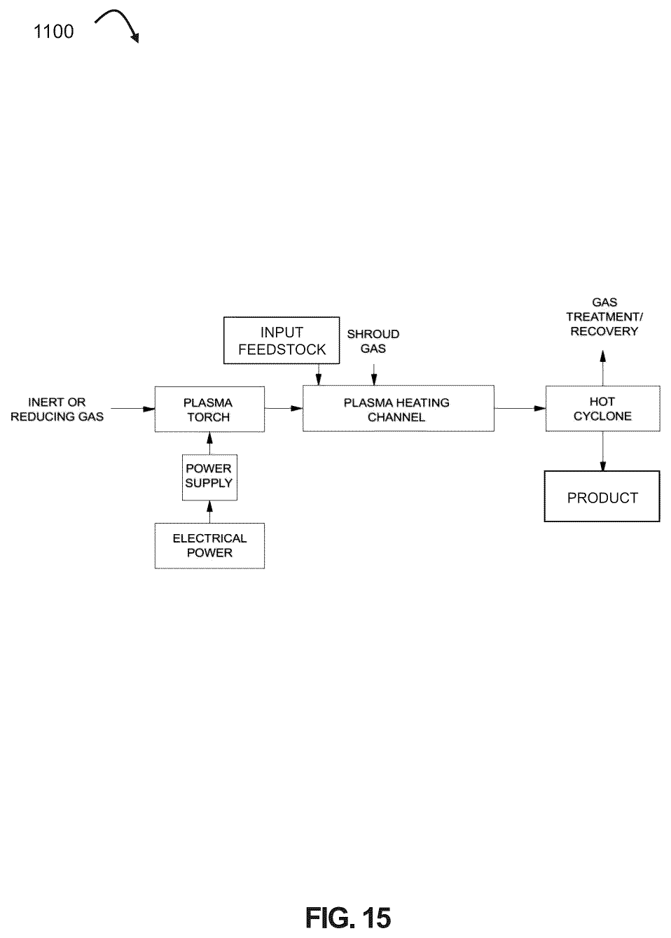

FIG. 15 shows an exemplary operation pattern 1100 for a system for processing an input feedstock using thermal plasma to obtain a product and providing a gas for treatment and recovery.

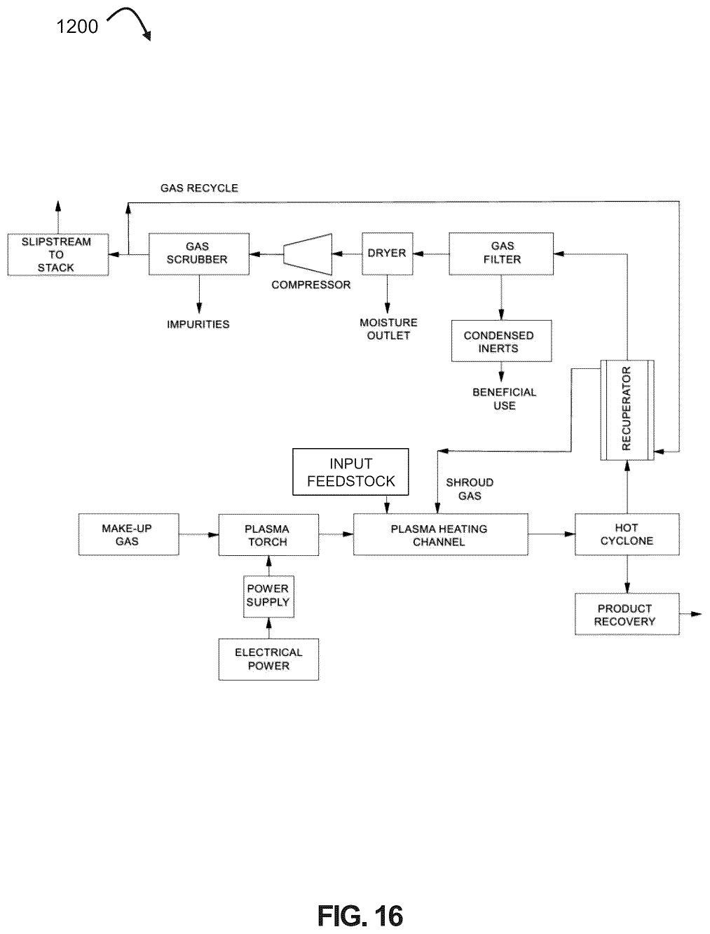

FIG. 16 shows an exemplary operation pattern 1200 for a system for separating an input feedstock using thermal plasma to recover a product and provide a gas for further processing to then be recovered, recycled, and/or removed via a stack.

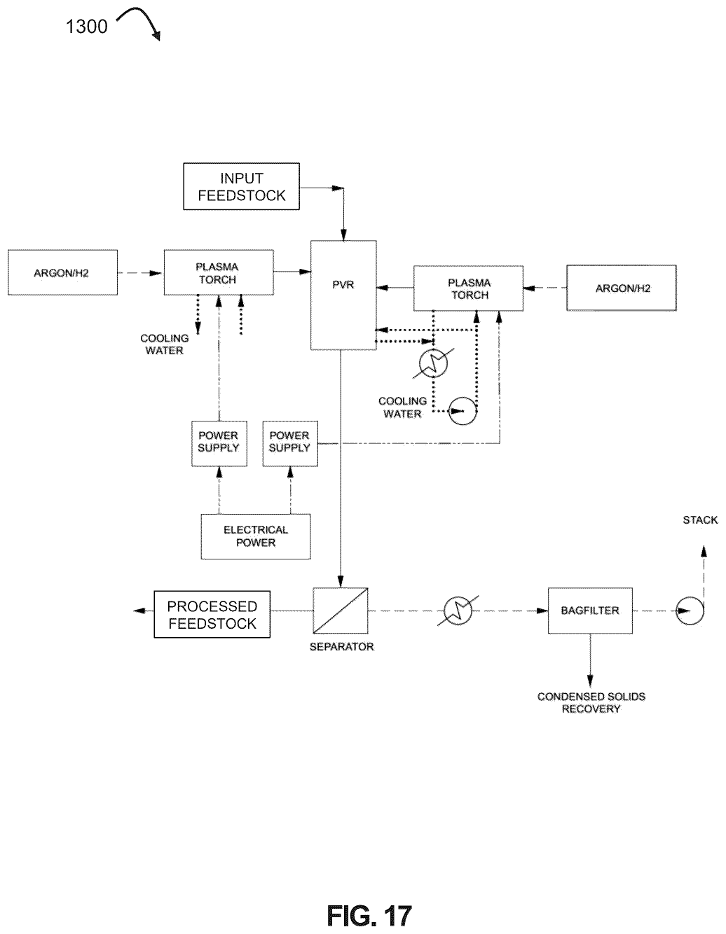

FIG. 17 shows an exemplary operation pattern 1300 for a system for separating an input feedstock using thermal plasma to obtain a processed feedstock and recover condensed solids.

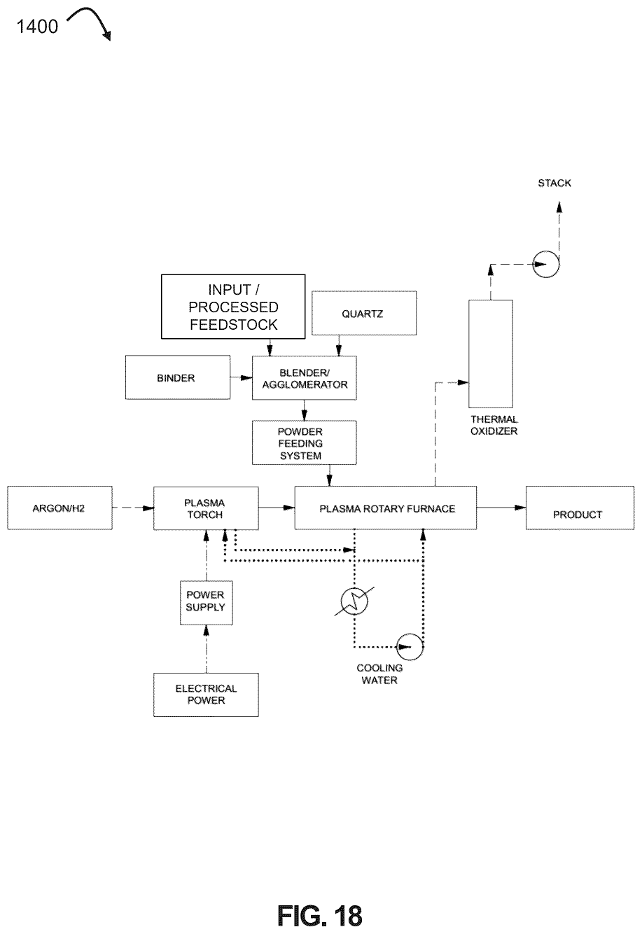

FIG. 18 shows an exemplary operation pattern 1400 for a system for forming a product from an input or processed feedstock using agglomeration and thermal plasma.

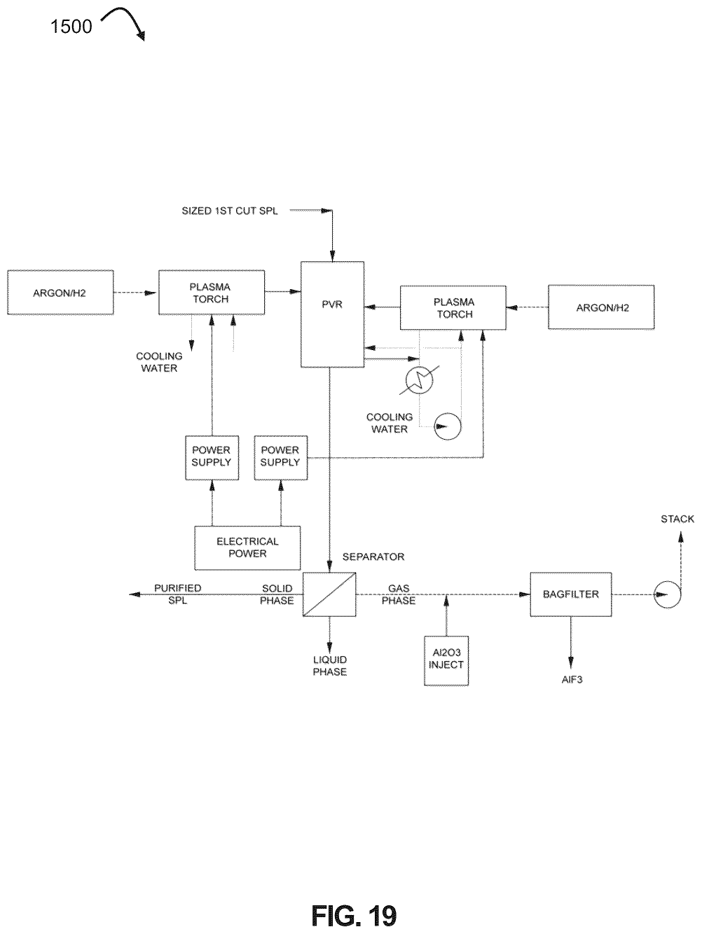

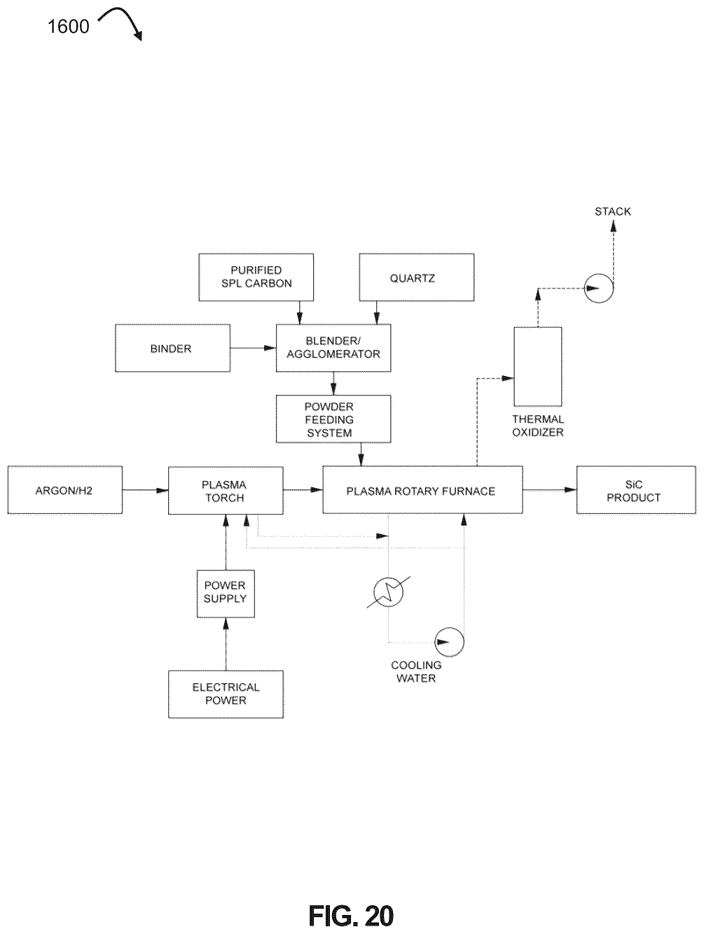

FIGS. 19 and 20 show an exemplary operation pattern 1500 for a system for separating a spent potliner using thermal plasma to obtain carbon and fluoride and remove cyanide, and an exemplary operation pattern 1600 for a system for producing silicon carbide using thermal plasma.

### EXEMPLARY EMBODIMENTS

The following represent exemplary and non-limiting embodiments of the present disclosure:
(1) A method for separating an input feedstock using thermal plasma technology to obtain a processed feedstock and/or remove one or more hazardous compounds, the method comprising the steps of: providing the input feedstock to a plasma vortex reactor; applying plasma to the plasma vortex reactor to heat the input feedstock and form a heated feedstock; and separating the input feedstock into at least one of a liquid phase, a solid phase, and a gas phase to obtain the processed feedstock and/or remove the one or more hazardous compounds separated from other substances of the heated feedstock.
(2) The method of paragraph 1, further comprising a step of treating the at least one of a liquid phase, the solid phase, and the gas phase to obtain one or more critical raw materials and/or remove another of the one or more hazardous compounds separated from the other substances.
(3) The method of paragraphs (1) or (2), wherein the step of separating the heated feedstock comprises separating the heated feedstock into a liquid phase, a solid phase, and a gas phase.
(4) The method of any one of paragraphs (1) to (3), further comprising a step of processing the input feedstock prior to the step of providing the input feedstock to a plasma vortex reactor.
(5) The method of paragraph (4), wherein the step of processing comprises reducing a particle size of the waste feedstock to between about 0.01 mm and about 4 mm.
(6) The method of any one of paragraphs (1) to (5), wherein the input feedstock is a hazardous waste feedstock.
(7) The method of any one of paragraphs (1) to (6), wherein the input feedstock comprises carbon.
(8) The method of paragraph (7), wherein the processed feedstock comprises carbon.
(9) The method of any one of paragraphs (1) to (8), wherein the step of applying plasma to the plasma vortex reactor comprises: pyrolyzing one or more substances of the input feedstock; vitrifying the one or more substances of the input feedstock; thermally destroying the one or more substances of the input feedstock; liquifying the one or more substances of the input feedstock; volatilizing the one or more substances of the input feedstock; or any combination thereof.
(10) A method for recovering one or more critical raw materials and/or removing one or more hazardous compounds separating from a spent potliner using thermal plasma, the method comprising the steps of: providing the spent potliner to a plasma vortex reactor; applying plasma to the plasma vortex reactor to heat the spent potliner and form a heated spent potliner and remove at least one of the one or more hazardous compounds; separating the heated spent potliner into a liquid phase, a solid phase, and a gas phase to recover a first of the one or more critical raw materials separated from other substances from the solid phase; and treating the gas phase to further recover a second of the one or more critical raw materials; wherein the one or more critical raw materials comprises carbon and fluoride and the one or more hazardous compounds comprises cyanide.
(11) The method of paragraph (10), further comprising a step of processing the spent potliner prior to the step of providing the spent potliner to a plasma vortex reactor.
(12) The method of paragraph (11), wherein the step of processing comprises reducing a particle size of the spent potliner to a desired particle size.
(13) The method of paragraph (12), wherein the desired particle size comprises a particle size between about 0.02 mm and about 4 mm.
(14) The method of any one of paragraphs (10) to (13), wherein the step of separating the heated spent potliner comprises recovering carbon from the solid phase as the first of the one or more critical raw materials.
(15) The method of any one of paragraphs (10) to (14), wherein the step of treating the gas phase comprises injecting alumina powder into the gas phase to obtain fluoride as the second of the one or more critical raw materials.
(16) The method of paragraph (15), wherein the fluoride comprises aluminum fluoride.
(17) The method of any one of paragraphs (10) to (16), wherein the step of applying plasma to the plasma vortex reactor comprises: pyrolyzing one or more substances of the spent potliner; vitrifying the one or more substances of the spent potliner; thermally destroying the one or more substances of the spent potliner; liquifying the one or more substances of the spent potliner; volatilizing the one or more substances of the spent potliner; or any combination thereof.
(18) The method of any one of paragraphs (10) to (17), wherein the step of applying plasma to the plasma vortex reactor comprises: vitrifying inorganic species of the spent potliner; thermally destroying the cyanide of the spent potliner; volatilizing the fluoride of the spent potliner; or any combination thereof.
(19) The method of paragraph (18), wherein the liquid phase comprises the inorganic species.
(20) The method of any one of paragraphs (10) to (19), wherein the first of the one or more critical raw materials is a purified spent potliner that comprises the carbon.
(21) The method of paragraph (20), further comprising steps of: mixing the purified spent potliner and one or more additional feedstocks to form an agglomerated carbon silica; delivering the agglomerated carbon silica to a plasma rotary furnace; applying plasma to the plasma rotary furnace to heat the agglomerated carbon silica and form silicon carbide; and recovering the silicon carbide.
(22) The method of paragraph (21), wherein the one or more additional feedstocks comprises quartz and optionally a binder.
(23) The method of paragraph (21) or (22), wherein the step of recovering the silicon carbide is a continuous mode recovery of the silicon carbide.
(24) The method of any one of paragraphs (21) to (23), wherein the silicon carbide comprises a C:Si mole ratio from about 2 to about 4.
(25) A method for processing a input feedstock using thermal plasma, the method comprising the steps of: providing the input feedstock to a plasma vortex reactor; applying plasma to the plasma vortex reactor to heat the input feedstock and form a heated feedstock; separating the heated feedstock into at least one of a liquid phase, a solid phase, and a gas phase to obtain a processed feedstock and/or remove one or more hazardous compounds separated from other substances; mixing the processed feedstock and one or more additional feedstocks to form a mixed feedstock; delivering the mixed feedstock to a plasma rotary furnace; applying plasma to the plasma rotary furnace to heat the mixed feedstock and form a product; and recovering the product.
(26) The method of paragraph (25), further comprising a step of treating the at least one of a liquid phase, the solid phase, and the gas phase to obtain one or more critical raw materials and/or remove another of the one or more hazardous compounds separated from the other substances.
(27) The method of paragraph (25) or (26), further comprising a step of processing the input feedstock prior to the step of providing the input feedstock to a plasma vortex reactor.
(28) The method of paragraph (27), wherein the step of processing comprises reducing a particle size of the input feedstock to a particle size between about 0.01 mm and about 4 mm.
(29) The method of any one of paragraphs (25) to (28), wherein the input feedstock is a hazardous feedstock.
(30) The method of any one of paragraphs (25) to (29), wherein the input feedstock comprises carbon.
(31) The method of paragraph (30), wherein the processed feedstock comprises carbon.
(32) The method of any one of paragraphs (25) to (31), wherein the step of applying plasma to the plasma vortex reactor comprises: pyrolyzing one or more substances of the input feedstock; vitrifying the one or more substances of the input feedstock; thermally destroying the one or more substances of the input feedstock; liquifying the one or more substances of the input feedstock; volatilizing the one or more substances of the input feedstock; or any combination thereof.
(33) The method of any one of paragraphs (25) to (32), further comprising a step of processing the processed feedstock prior to the step of mixing the processed feedstock and the one or more additional feedstocks.
(34) The method of any one of paragraphs (25) to (33), wherein the one or more additional feedstocks comprises either or both of a binder and one or more further components.
(35) The method of any one of paragraphs (25) to (34), wherein the mixed feedstock comprises an agglomerate.
(36) The method of any one of paragraphs (25) to (35), wherein the step of recovering the product comprises a continuous mode recovery of the product.
(37) The method of any one of paragraphs (21) to (36), wherein the step of applying plasma to the plasma rotary furnace comprises heating an interior of the plasma rotary furnace to a temperature of about 2,500° C.
(38) The method of any one of paragraphs (21) to (37), wherein the plasma is delivered to a reaction compartment of the plasma rotary furnace by one or more plasma torches.
(39) The method of any one of paragraphs (21) to (38), wherein the step of applying plasma to the plasma rotary furnace comprises torch operation on any gas suitable for plasma.
(40) The method of any one of paragraphs (21) to (39), wherein the step of applying plasma to the plasma rotary furnace comprises torch operation on nitrogen, oxygen, carbon dioxide, argon, hydrogen, helium, air, or any combination thereof.
(41) The method of any one of paragraphs (21) to (40), wherein the step of applying plasma to the plasma rotary furnace comprises torch operation on either or both of argon and hydrogen.
(42) The method of any one of paragraphs (21) to (41), wherein the product comprises silicon carbide, tungsten carbide, boron carbide, or any combination thereof.
(43) The method of any one of paragraphs (1) to (42), wherein the plasma is delivered to a reaction compartment of the plasma vortex reactor by two or more plasma torches.
(44) The method of any one of paragraphs (1) to (43), wherein the two or more plasma torches are positioned tangentially at two or more different flow planes for forming two or more tangential plasma vortices having different directions within the plasma vortex reactor.
(45) The method of any one of paragraphs (1) to (44), wherein at least two of the two or more plasma torches are positioned tangentially at two different flow planes for forming counter rotating tangential plasma vortices within the plasma vortex reactor.
(46) The method of any one of paragraphs (1) to (45), wherein the step of applying plasma to the plasma vortex reactor comprises torch operation on any gas suitable for plasma.
(47) The method of any one of paragraphs (1) to (46), wherein the step of applying plasma to the plasma vortex reactor comprises torch operation on nitrogen, oxygen, carbon dioxide, argon, hydrogen, helium, air, or any combination thereof.
(48) The method of any one of paragraphs (1) to (47), wherein the step of applying plasma to the plasma vortex reactor comprises torch operation on either or both of argon and hydrogen.
(49) The method of any one of paragraphs (1) to (48), wherein the step of applying plasma comprises heating an interior of the plasma vortex reactor to about 3,000° C.
(50) A method for producing a product using thermal plasma, the method comprising the steps of: mixing an input feedstock and one or more additional feedstock to form a mixed feedstock; delivering the mixed feedstock to a plasma rotary furnace; applying plasma to the plasma rotary furnace to heat the mixed feedstock and form the product; and recovering the product.
(51) A system for separating an input feedstock using thermal plasma to obtain a processed feedstock and/or remove one or more hazardous compounds, the system comprising: a plasma vortex reactor for heating the input feedstock to a heated feedstock, the plasma vortex reactor comprising two or more plasma torches; and a separator operationally connected to the plasma vortex reactor, the separator for separating the heated feedstock into at least one of a liquid phase, a solid phase, and a gas phase for obtaining the processed feedstock and/or removing the one or more hazardous compounds.
(52) The system of paragraph (51), further comprising a treatment assembly operationally connected to the separator and/or the plasma vortex reactor, the treatment assembly for treating the at least one of a liquid phase, the solid phase, and the gas phase to obtain one or more critical raw materials and/or remove another of the one or more hazardous compounds separated from the other substances.
(53) The system of paragraph (51) or (52), further comprising a processing assembly operationally connected to the plasma vortex reactor, the processing assembly for processing the input feedstock.
(54) A system for recovering one or more critical raw materials and/or remove one or more hazardous compounds from a spent potliner using thermal plasma, the system comprising: a plasma vortex reactor for heating the spent potliner to a heated spent potliner and removing the one or more hazardous compounds, the plasma vortex reactor comprising two or more plasma torches; a separator operationally connected to the plasma vortex reactor, the separator for separating the heated spent potliner into a liquid phase, a solid phase, and a gas phase, and obtaining a first of the one or more critical raw materials from the solid phase; and a treatment assembly operationally connected to the separator, the treatment assembly for treating the gas phase to obtain a second of the one or more critical raw materials; wherein the one or more critical raw materials comprises carbon and fluoride and the one or more hazardous compounds comprises cyanide.
(55) The system of paragraph (54), wherein the first of the one or more critical raw materials comprises carbon.
(56) The system of paragraph (54) or (55), wherein the first of the one or more critical raw materials is a purified spent potliner that comprises carbon.
(57) The system of any one of paragraphs (54) to (56), wherein the second of the one or more critical raw materials comprises fluoride.
(58) The system of any one of paragraphs (54) to (57), wherein the treatment assembly comprises an injector and a filter.
(59) The system of paragraph (58), wherein the injector provides alumina powder to the gas phase.
(60) The system of any one of paragraphs (54) to (59), wherein the second of the one or more critical raw materials is aluminum fluoride.
(61) The system of any one of paragraphs (51) to (60), whereby, in operation, an interior of the plasma vortex reactor reaches a temperature of about 3,000° C.
(62) The system of any one of paragraphs (51) to (61), wherein the two or more plasma torches are positioned tangentially at two or more different flow planes for forming two or more tangential plasma vortices having different directions within the plasma vortex reactor.
(63) The system of any one of paragraphs (51) to (62), wherein at least two of the two or more plasma torches are positioned tangentially at two different flow planes for forming counter rotating tangential plasma vortices within the plasma vortex reactor.
(64) The system of any one of paragraphs (51) to (63), the two or more plasma torches operate on any gas suitable for plasma.
(65) The system of any one of paragraphs (51) to (64), the two or more plasma torches operate on nitrogen, oxygen, carbon dioxide, argon, hydrogen, helium, air, or any combination thereof.
(66) The system of any one of paragraphs (51) to (65), the two or more plasma torches operate on either or both of argon and hydrogen.
(67) The system of any one of paragraphs (51) to (66), wherein either or both of the plasma vortex reactor and the separator comprises a channel for receivably conveying a liquid phase.
(68) The system of any one of paragraphs (52) to (67), further comprising a cooling apparatus for water cooling either or both of the plasma vortex reactor and the treatment assembly.
(69) The system of any one of paragraphs (54) to (68), further comprising a processing assembly operationally connected to the plasma vortex reactor, the processing assembly for reducing a particle size of the spent potliner to between about 0.01 mm and about 4 mm.
(70) The system of any one of paragraphs (51) to (69), wherein the plasma vortex reactor is oriented horizontally.
(71) The system of any one of paragraphs (54) to (70), further comprising: a blender operationally connected to the separator for agglomerating the processed feedstock with one or more additional feedstocks to form a mixed feedstock; and a plasma rotary furnace operationally connected to the blender for heating the mixed feedstock and forming a product, the plasma rotary furnace comprising one or more plasma torches.
(72) The system of paragraph (71), whereby, in operation, an interior of the plasma rotary furnace reaches a temperature of about 2,500° C.
(73) The system of paragraph (71) or (72), wherein the plasma rotary furnace comprises a continuous mode recovery of the silicon carbide.

In the present disclosure, all terms referred to in singular form are meant to encompass plural forms of the same. Likewise, all terms referred to in plural form are meant to encompass singular forms of the same. Unless defined otherwise, all technical and scientific terms used herein have the same meaning as commonly understood by one of ordinary skill in the art to which this disclosure pertains.

As used herein, the term “about” refers to an approximately +/−10% variation from a given value. It is to be understood that such a variation is always included in any given value provided herein, whether or not it is specifically referred to.

It should be understood that the compositions and methods are described in terms of “comprising,” “containing,” or “including” various components or steps, the compositions and methods can also “consist essentially of or “consist of the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Although individual embodiments are dis-cussed, the disclosure covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. If there is any conflict in the usages of a word or term in this specification and one or more patent(s) or other documents that may be referenced herein, the definitions that are consistent with this specification should be adopted.

Many obvious variations of the embodiments set out herein will suggest themselves to those skilled in the art in light of the present disclosure. Such obvious variations are within the full intended scope of the appended claims.

1. A method for separating an input feedstock using thermal plasma technology to obtain a processed feedstock and/or remove one or more hazardous compounds, the method comprising the steps of:
providing the input feedstock to a plasma vortex reactor;
applying plasma to the plasma vortex reactor to heat the input feedstock and form a heated feedstock; and
separating the input feedstock into at least one of a liquid phase, a solid phase, and a gas phase to obtain the processed feedstock and/or remove the one or more hazardous compounds separated from other substances of the heated feedstock.

2. The method of claim 1, further comprising a step of treating the at least one of a liquid phase, the solid phase, and the gas phase to obtain one or more critical raw materials and/or remove another of the one or more hazardous compounds separated from the other substances.

3. The method of claim 1, further comprising a step of processing the input feedstock prior to the step of providing the input feedstock to a plasma vortex reactor.

4. The method of claim 3, wherein the step of processing comprises reducing a particle size of the waste feedstock to a desired particle size.

5. The method of claim 1, wherein the input feedstock comprises carbon.

6. The method of claim 1, wherein the processed feedstock comprises carbon.

7. The method of claim 1, wherein the step of applying plasma to the plasma vortex reactor comprises:
pyrolyzing one or more substances of the input feedstock
vitrifying one or more substances of the input feedstock;
thermally destroying the one or more substances of the input feedstock;
liquifying the one or more substances of the input feedstock;
volatilizing the one or more substances of the input feedstock; or
any combination thereof.

8. The method of claim 1, wherein the step of applying plasma comprises delivering plasma to a reaction compartment of the plasma vortex reactor by two or more plasma torches.

9. The method of claim 8, wherein at least two of the two or more plasma torches are positioned tangentially at two different flow planes for forming counter rotating tangential plasma vortices within the plasma vortex reactor.

10. The method of claim 1, wherein the step of applying plasma comprises heating an interior of the plasma vortex reactor to about 3,000° C.

11. The method of claim 1, further comprising the steps of:
mixing the processed feedstock and one or more additional feedstocks to form a mixed feedstock;
delivering the mixed feedstock to a plasma rotary furnace;
applying plasma to the plasma rotary furnace to heat the mixed feedstock and form the product; and
recovering the product.

12. The method of claim 11, wherein the one or more additional feedstocks comprise either or both of a binder and a further component.

13. The method of claim 11, wherein the mixed feedstock comprises an agglomerate.

14. The method of claim 11, wherein the step of applying plasma to the plasma rotary furnace comprises heating an interior of the plasma rotary furnace to a temperature of about 2,500° C.

15. The method of claim 11, wherein the step of recovering the product comprises a continuous mode recovery of the product.

16. The method of claim 11, wherein the product comprises silicon carbide, tungsten carbide, boron carbide, or any combination thereof.

17. A method for producing a product using thermal plasma, the method comprising the steps of:
mixing an input feedstock and one or more additional feedstock to form a mixed feedstock;
delivering the mixed feedstock to a plasma rotary furnace;
applying plasma to the plasma rotary furnace to heat the mixed feedstock and form the product; and
recovering the product.

18. The method of claim 17, wherein the step of applying plasma to the plasma rotary furnace comprises heating an interior of the plasma rotary furnace to a temperature of about 2,500° C.

19. The method of claim 17, wherein the step of recovering the product comprises a continuous mode recovery of the product.

20. The method of claim 17, wherein the product comprises silicon carbide, tungsten carbide, boron carbide, or any combination thereof.
